(19) United States
(12) Patent Application Publication
(10) Pub. No.: US 2019/0071256 A1
(43) Pub. Date: Mar. 7, 2019

(54) SORTING DEVICE OF BULK CONTAINERS WITH AUTOMATIC SIZE CHANGE

(71) Applicant: LANFRANCHI S.R.L., Collecchio (PR) (IT)

(72) Inventor: Mario LANFRANCHI, Collecchio (PR) (IT)

(73) Assignee: LANFRANCHI S.R.L., Collecchio (PR) (IT)

(21) Appl. No.: 16/077,247

(22) PCT Filed: Feb. 10, 2017
(86) PCT No.: PCT/EP2017/053028

§ 371 Date: Aug. 10, 2018

(30) Foreign Application Priority Data
Feb. 11, 2016 (IT) UB2016A000654

(51) Int. Cl. B65G 47/14; B65G 47/256

(52) U.S. Cl. CPC B65G 47/1457; B65G 2201/0235; B65G 47/256

(57) ABSTRACT

A sorting machine, or unscrambler of bulk containers, including a first carousel and a second carousel on which a series of cradles are mounted which are adapted to receive the containers in a horizontal position, a series of straightening dischargers, a series of separation frames, more generally separators, having the function of receiving the container discharged by the overhead discharge channels; and wherein at least one of the series of cradles and/or dischargers and/or separators has at least one element or wall movable in width or in depth. The machine includes automatic actuation devices configured to move the movable element or wall, wherein the devices are arranged outside the first and second carousels.

### SCOPE OF THE INVENTION

The present invention relates to the field of machinery for orienting and aligning containers, also known as unscramblers and more specifically, it relates to a system for the automatic adjustment of the compartments that select, straighten, sort and align the containers.

The invention protects both the machine and the method.

### PRIOR ART

Sorting machines are known, such as those described in patent documents EP1590276, EP1601594, EP0877711; in essence, these are machines used to sort and align the containers arranged in bulk with a rotating hopper in which bulk containers are thrown; the hopper is a rotating according to a vertical rotation axis; from the hopper, lifting means carry the containers on the upper edge to then drop them into a plurality of horizontal cradles with underlying vertical discharge channels shaped as funnels and integral with the outer wall of the cylindrical hopper; a carousel rotating at a speed different from that of the cylindrical hopper carries a plurality of separation channels below the discharge channels.

Sorting machines are known for the complexity of managing different sizes, since important “size changeover” times are required since this machine needs the replacement of several mechanical elements belonging to both the cradles, the dischargers and the separators.

Sorting machines are known in the prior art which have a “size change” of the separation frames which is done by manual adjustment of its parts without replacement of mechanical parts.

Some sorting machines have recently been improved by trying to carry out an automatic recipe “size change” without manual adjustment or replacement of mechanical parts; said sorting machines have adjustment motion transmission systems inside the carousels and thus these are not easily accessible for ordinary and extraordinary maintenance.

### DESCRIPTION AND ADVANTAGES OF THE INVENTION

One object of the present invention is to provide an improved automatic “size change” of cradles, discharge channels or separators within a rational and simple solution that significantly reduces the productivity losses related to the “size change”.

With the invention, one has the possibility to change the size of the section of said cradles, dischargers, separators that receives the container without resorting to the removal and replacement of frames with others of appropriate size and without having to intervene with manual adjustments.

These and other objects are achieved with the features of the invention described in the independent claim 1. The dependent claims describe preferred and/or particularly advantageous aspects of the invention.

In particular, an embodiment of the present invention provides a system for changing the compartments via automatic actuation means, such as motor drives and mechanical motion transmission systems placed on the outer surface of the carousels and thus easily accessible for performing checks and ordinary or extraordinary maintenance.

With this solution, one has the possibility of using different types of container size without having to resort to the replacement of mechanical elements; in addition, each wall that needs adjustment can be controlled in a centralized manner, so that the same adjustable wall of two or more cradles, as well as the same adjustable wall present on two or more dischargers or separators is driven by a single common drive, each wall being integral with the adjacent wall through mechanical connecting elements.

Moreover, one has maximum flexibility since both linear and radial variations of the adjustable walls, such as edges and/or backs, can be carried out.

The invention also protects the method of adjusting the cradles and the discharge channels and the separators in an unscrambler of bulk containers, characterized in that it provides for moving the movable elements or walls of said machine via means arranged outside of the same and acting, with a drive, on at least two corresponding walls of two different cradles and/or dischargers and/or separators.

In addition, the invention provides for using only one motor drive for the same element or movable wall of the sorting machine to be actuated, thus saving on the motor drives.

Said objects and advantages are all achieved by the sorting machine with automatic “size change” object of the present invention, which is characterized by the following claims.

### BRIEF DESCRIPTION OF THE FIGURES

This and other features will become more apparent from the following description of some of the configurations, illustrated purely by way of example in the accompanying drawings.

FIG. 1: shows an overall view of a sorting machine,

FIG. 2: shows an outer portion of the machine with the two carousels, carrying cradles, dischargers and separators, with annexed automatic “size change” system according to the invention, with automatic actuation means, of the chain type in the example, arranged outside of the carousel,

FIG. 3: shows a portion of the sorting machine with a front and back view of the cradle and the discharger that is provided with one or more walls adjustable by means of automatic actuation means,

FIG. 4: shows a portion of the sorting machine with a front view of the separator that is provided with one or more walls adjustable by means of automatic actuation means,

FIG. 5: shows a portion of the sorting machine with a back view of the cradles and dropping dischargers, comprising mechanical elements for the radial and linear adjustment,

FIG. 6: shows a portion of the sorting machine with a back view of the separator, comprising mechanical elements for the radial and linear adjustment,

FIG. 7: shows the dropping and straightening steps of the container during its fall from the cradles to the dischargers, up to the separator,

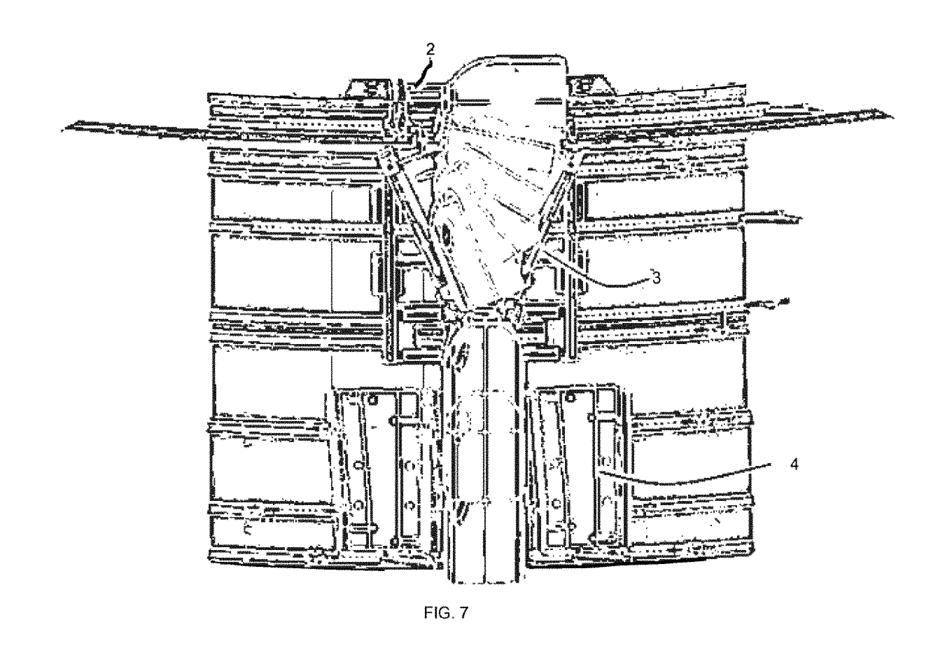

FIG. 8: shows a sectional view of sorting machine of containers, with a plurality of cradles and dischargers applied on the upper carousel or loading hopper, and a plurality of separators on the lower carousel.

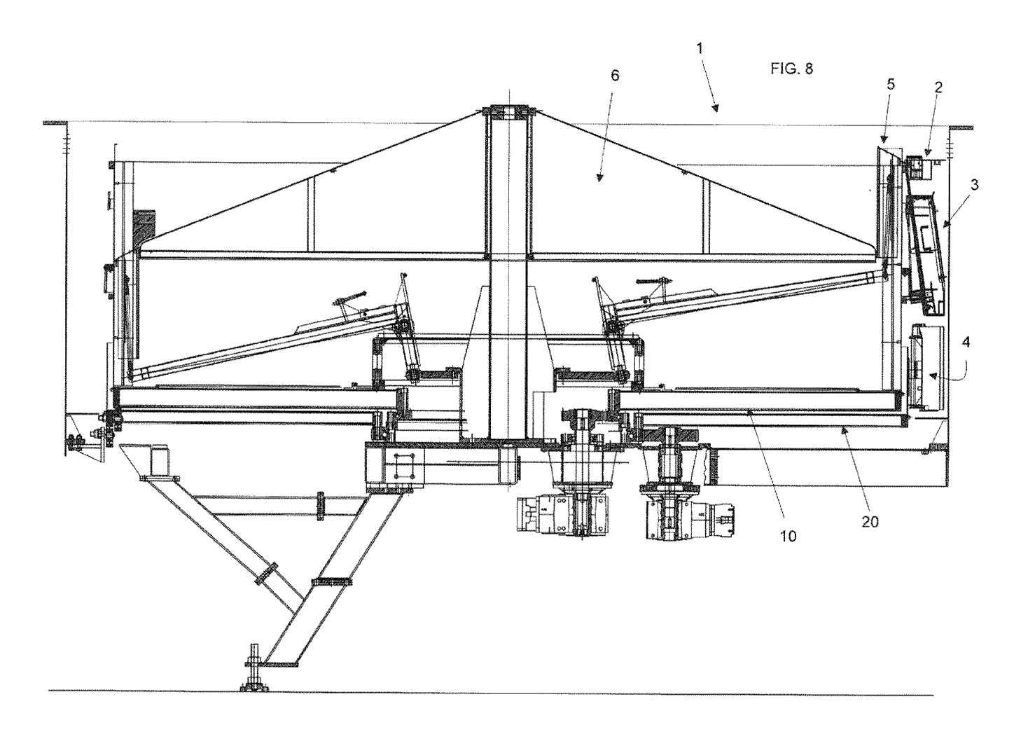

### DESCRIPTION OF THE INVENTION

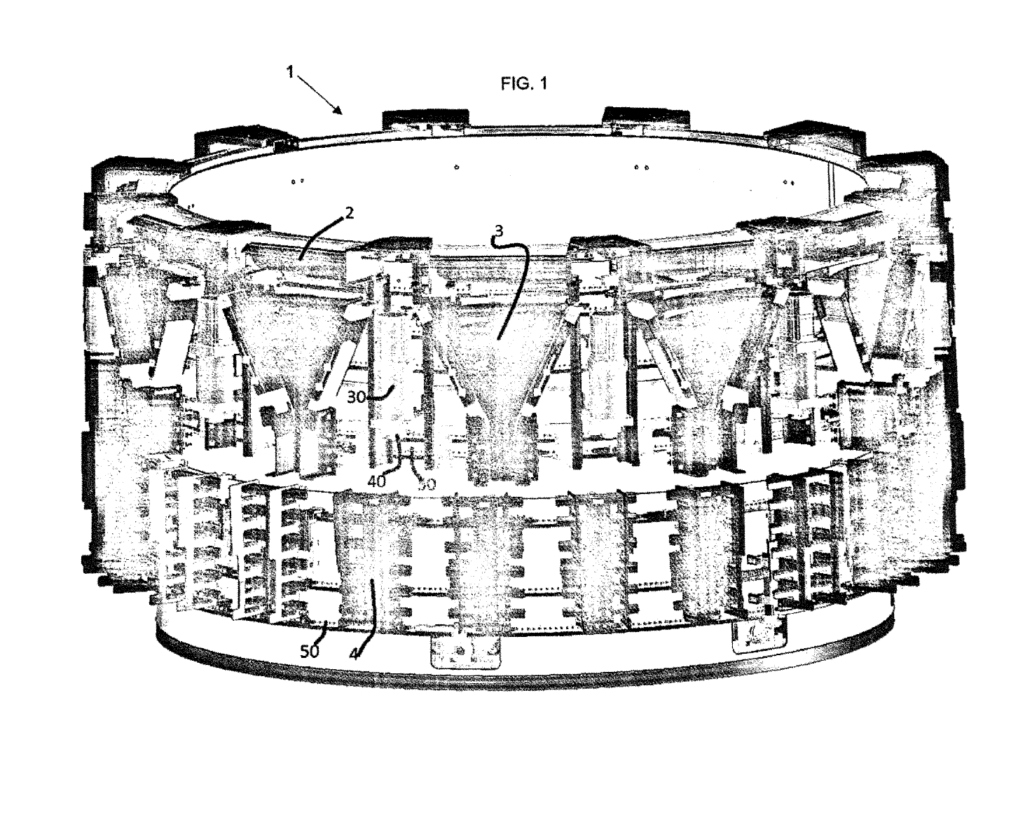

With particular reference to FIG. 1, reference numeral 1 indicates a sorting machine of containers (bottles, preforms) preferably made of plastic; the machine is also known as unscrambler; as is known, it comprises means for selecting the containers, and placing them according to a suitable placement.

Precisely, said sorting machine of bulk containers is rotating according to a central vertical rotation axis BB and comprising a first carousel 10 and a second carousel 20; a series of cradles 2 are integral outside carousel 10, adapted to receive containers in a horizontal position arriving from lifting means 5, adapted to carry the containers, from a central element 6 to the predetermined height corresponding to the positioning of cradles 2, below which the containers are straightened by means of a series of dischargers 3, which are also integral to the first carousel 10 and placed on the outer face thereof; the second carousel 20, so-called of the separators, where the containers fall in vertical position, is concentric to the first carousel 10 and on its outer face comprises a series of separation frames with the function of receiving the container discharged by the overhead dischargers 3; at least one between said series of cradles 2 and/or series of dischargers 3 and/or series of separators 4 is provided with one or more adjustable walls either in width 31, 32, 22, 41, 42 or in depth 21, 31, 41.

The two fins 32 of the discharger can be adjusted independently of each other.

Specifically, the invention provides for applying automatic actuation means 30, 40, 50 to one or more elements or walls acting on at least a series of CRADLES and/or DISCHARGERS and/or frames 4.

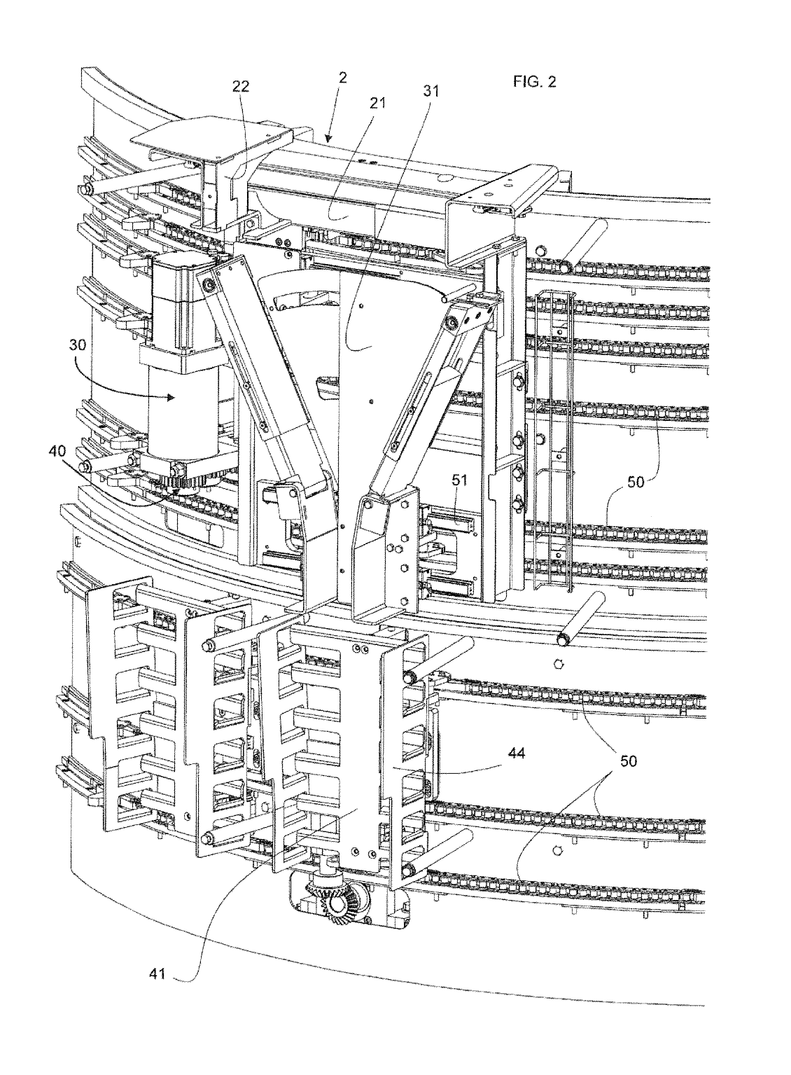

Means 30, 40, 50 are arranged outside carousel 10 and/or 20, as shown in FIGS. 1 and 2, and are capable of driving at least one element or a movable wall of said groups 2, 3, 4.

According to a first generic variant, said means 30, 40, 50 are configured to act on at least two corresponding walls of two different cradles 2 and/or dischargers 3 and/or frames 4. As an alternative, said means 30, 40, 50 are configured to act on at least two corresponding walls of two different and adjacent cradles 2 and/or dischargers 3 and/or separators 4.

It is also noted that if one has to act on different elements or walls to be driven of a same or different group 2, 3, 4, the invention provides for associating independent drive means 30, 40, 50 to each wall or element.

The automatic drive means comprise a motor drive 30 and a relative transmission member 40. In the example, said transmission member 40 is of the crown and rack type, wherein the crown is the pinion of the motor drive 30 and the rack is configured to move said connecting element 50.

Specifically, the connecting element 50 is a flexible element, preferably of the roller chain type, arranged along an arc of circumference that is coaxial to carousel 10 or 20 having such a length as to have both ends thereof connected to the rack of the transmission member 40.

Such automatic actuation means 30, 40, 50 are configured to carry out two types of adjustments or at least one of them:
a) adjustment in linear direction, which is a variation of position of the adjustable walls tangent to a circumference concentric to the corresponding carousel 10 and/or 20.
b) adjustment in radial direction, which is a variation of the distance of the adjustable walls from the structure of the corresponding carousel 10 and/or 20.

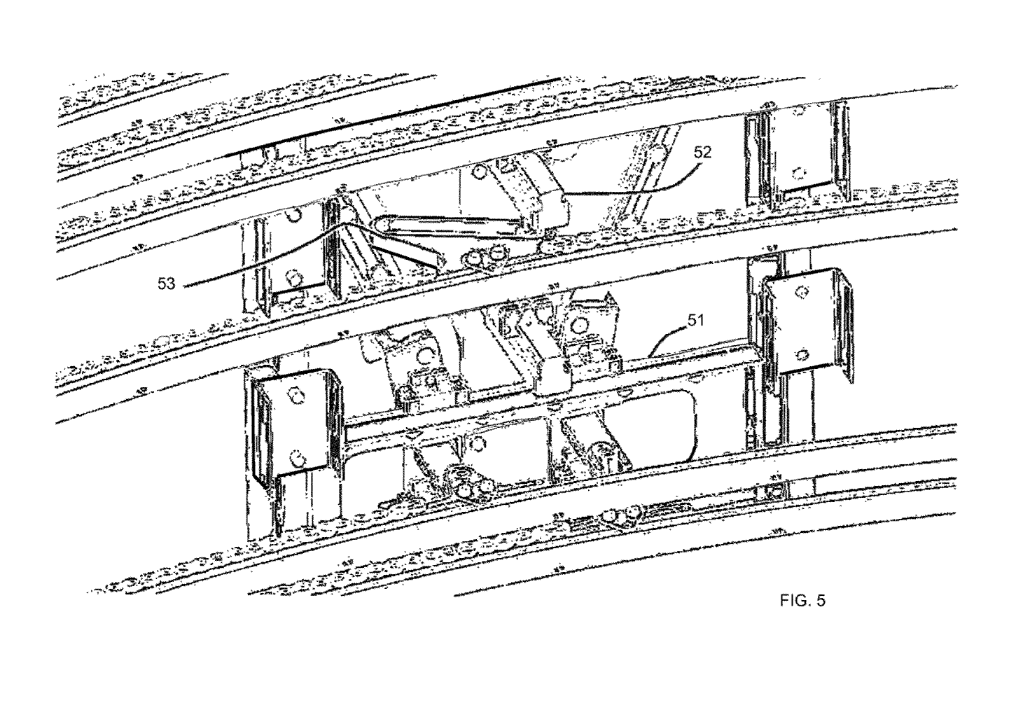

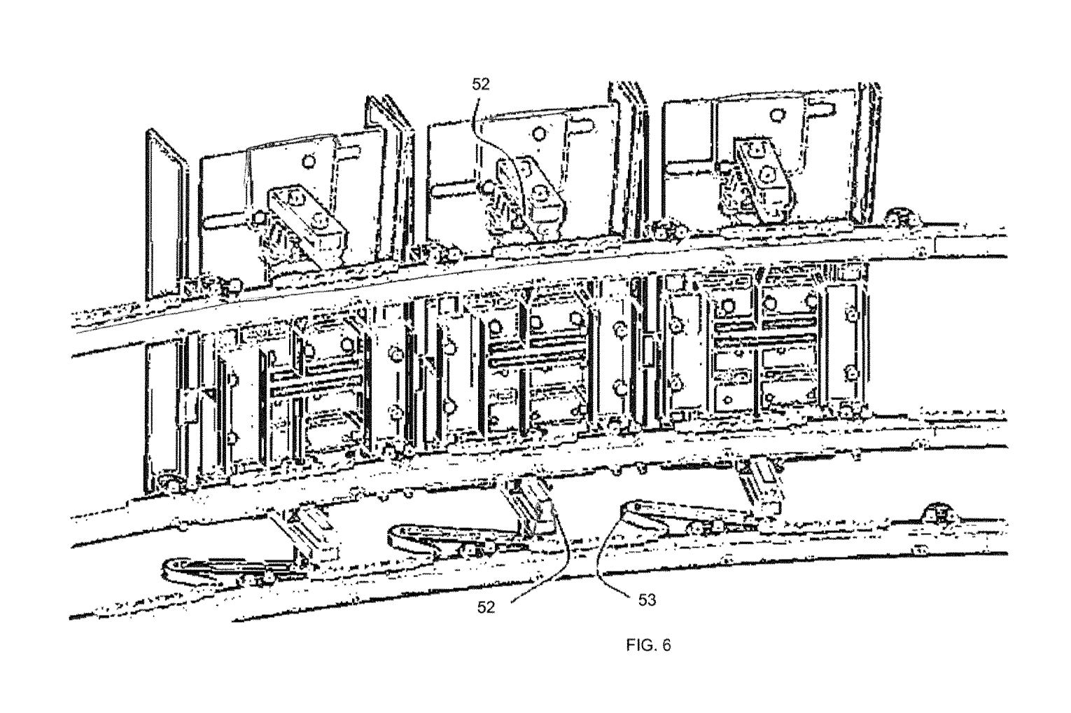

In particular, as shown in FIGS. 5 and 6, adjustable walls 31, 32, 22, 41, 42 in a linear direction are mounted on sliding elements 51 placed in a direction tangent to a circumference concentric and external to carousel 10 or 20; said sliding elements 51 are configured to receive motion from the connecting element 50.

Walls 21, 31, 41 adjustable in a radial direction are mounted on sliding elements 52 placed in a radial direction with respect to carousel 20 or 30; said sliding elements 52 configured to receive motion from the connecting element 50 by the interposition of a cam 53 configured to change the circumferential motion into radial motion.

The position of said adjustable walls of cradles 2 and/or dischargers 3 and/or separators 4 is a function of the type and size of the container to be treated.

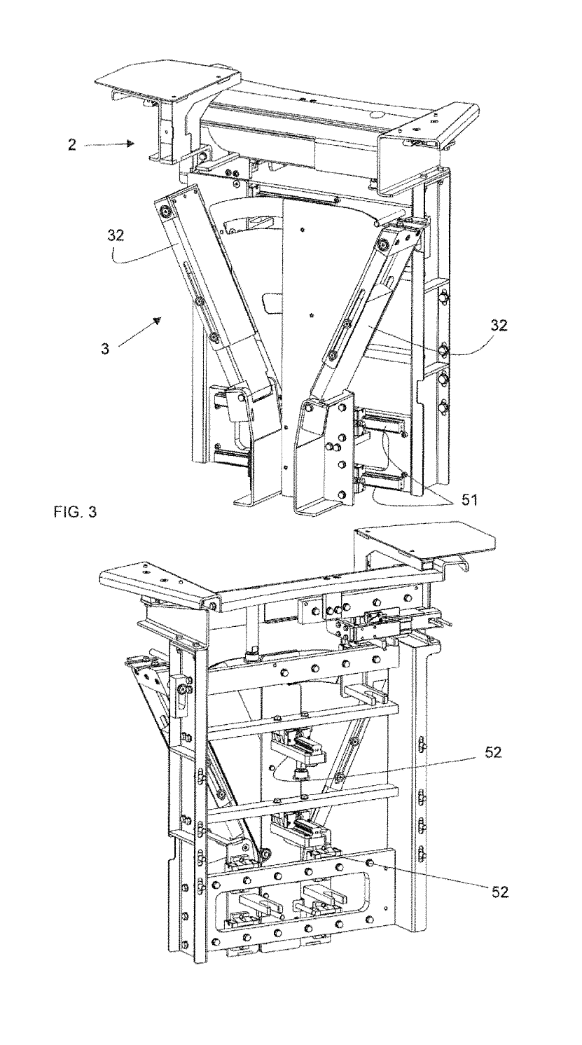

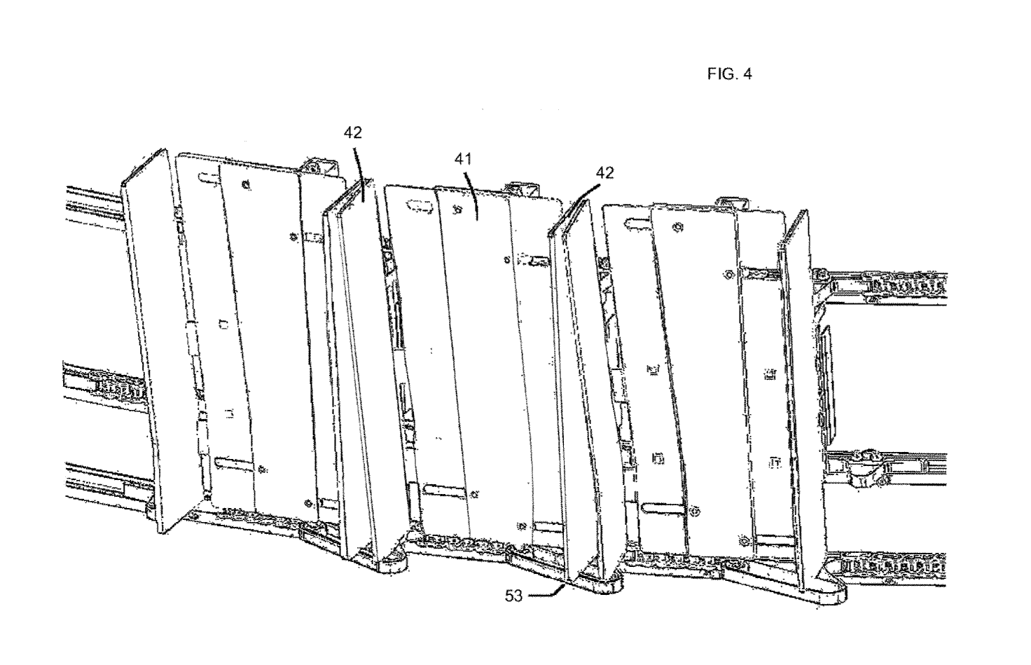

More precisely, FIGS. 3 and 4 show a possible configuration of cradles 2 and/or dischargers 3 and/or separators 4 which provides:
a) cradle 2 comprises a back 21 with adjustable guide in a radial direction and an edge 22 also adjustable in a linear direction,
b) Discharger 3 comprises one or more backs 31 adjustable in radial and linear direction and one or more edges 32 adjustable in a linear direction—the opposite edge can also be moved in direction,
c) Separator 4 comprises one or more backs 41 adjustable in radial and linear direction and one or more edges 42 adjustable in a linear direction.

In essence, the invention involves the use of automatic actuation means for adjusting and changing the position of the edges and backs of said cradles 3, dischargers 3 and separators 4 defining the compartment within which the container to be treated is received.

Corresponding edges or backs on two or more different cradles 2 and/or dischargers 3 and/or separators 4 are connected together by the flexible connecting elements 50; their position is adjusted automatically, at each change of the type of container or “size change”, by means of motor 30 and the transmission elements 40 which in turn act on the connecting elements 50 to which they are mechanically connected.

Therefore, actuating motor 30 changes the position of all corresponding adjustable walls, such as all walls 42 4 of separators 4 that are connected by the connecting elements 50.

Different walls require different automatic actuation means.

It is understood, however, that the above description is a non-limiting example, therefore possible variants of detail that may be necessary for technical and/or functional reasons are deemed as falling within the same protection scope defined by the following claims.

As will be clear from the description of the invention, the method of adjusting the cradles and the discharge channels and the separators of the unscrambler of bulk containers provides for moving the movable elements or walls of said machine via means arranged outside of the same and acting, with a drive, on at least two corresponding walls of two different cradles (2) and/or dischargers (3) and/or separators (4).

1. A sorting machine, or unscrambler of containers, wherein a plurality of bulk containers are selected, straightened, sorted and aligned within said machine, said machine being rotary according to a central vertical rotation axis and comprising a first carousel and a second carousel on which a series of cradles are mounted which are adapted to receive the containers in a horizontal position, a series of straightening dischargers; a series of separators are configured to receive the container discharged by the overhead dischargers; at least one of said series of cradles and/or dischargers and/or separators having at least one element or wall movable in width or in depth; the machine further comprising automatic actuation means configured to move said movable element or wall, where said means are arranged outside at least one chosen from the first carousel and the second carousel.

2. The machine according to claim 1, wherein said means are configured to act on at least two corresponding walls of two different cradles and/or dischargers and/or separators.

3. The machine according to claim 2, wherein said at least two corresponding walls of two different cradles and/or dischargers and/or separators are adjacent.

4. The machine according to claim 1, wherein said automatic actuation means comprise a motor drive and a relative transmission member and a connecting element.

5. The machine according to claim 4, wherein said transmission member is of the crown and rack type, wherein the crown is the pinion of the motor drive; the rack is configured to move said connecting element.

6. The machine according to claim 4, wherein said connecting element is arranged along an arc of circumference that is coaxial to the carousel or of such a length as to have both ends thereof connected to the rack of the transmission member.

7. The machine according to claim 4, wherein said connecting element is a flexible element.

8. The machine according to claim 1, wherein said automatic actuation means are configured to actuate a movement in the linear direction of at least one element or wall, so as to vary the position according to a direction tangent to a circumference concentric to the corresponding at least one chosen from the first carousel and the second carousel.

9. The machine according to claim 1, wherein the automatic actuation means are configured to actuate a movement in the radial direction of at least one element or wall, so as to vary the distance from the structure of the corresponding at least one chosen from the first carousel and the second carousel.

10. The machine according to claim 1, wherein multiple automatic actuation means are configured to actuate movements of multiple elements or walls, in radial or linear direction.

11. The machine according to claim 1, wherein independent drive means are associated with each movable element or wall of a series of cradles and/or dischargers and/or separators.

12. The machine according to claim 8, wherein said movable elements or walls in a linear direction are connectable to sliding elements placed in a direction tangent to a circumference concentric and external to the carousel or; said sliding elements adapted to receive motion from the connecting element.

13. The machine according to claim 9, wherein said elements or walls movable in a radial direction are connectable to sliding elements placed in a radial direction with respect to the carousel or; said sliding elements adapted to receive motion from the connecting element by the interposition of a cam configured to change the circumferential motion into radial motion.

14. A method of adjusting the cradles and the discharge channels and the separators in an unscrambler of bulk containers by providing for moving the movable elements or walls of said machine via means arranged outside of the same and acting, with a drive, on at least two corresponding walls of two different cradles and/or dischargers and/or separators.
